(19) United States
(12) Patent Application Publication
(10) Pub. No.: US 2021/0245336 A1
(43) Pub. Date: Aug. 12, 2021

(54) Wrench with Engaging Jaws

(71) Applicant: APEX BRANDS, INC., Apex, NC (US)

(72) Inventor: Jeromy Higgins, Apex, NC (US)

(21) Appl. No.: 17/154,233

(22) Filed: Jan. 21, 2021

Related U.S. Application Data
(60) Provisional application No. 62/975,401, filed on Feb. 12, 2020.

(51) Int. Cl. B25B 13/14

(52) U.S. Cl. CPC B25B 13/14

(57) ABSTRACT

An example wrench is provided. The example wrench includes a first jaw having a first jaw engaging surface configured to engage a first side of a fastener and a second jaw having a second jaw engaging surface configured to engage a second side of a fastener. A first plane defined by the first jaw engaging surface may intersect with a second plane defined by the second jaw engaging surface at an engagement angle. The engagement angle may be an acute angle.

### TECHNICAL FIELD

Example embodiments generally relate to hand tools, and in particular to wrench technology.

### BACKGROUND

Wrenches are often employed to engage with various types of fasteners to provide a user with leverage, via a handle, to turn the fastener. The fastener may be a nut or a bolt head that may be shaped (e.g., with a hexagon shape) where the edges of the fastener may physically contact engaging surfaces on the jaws of the wrench to engage and facilitate turning the fastener to either tighten or loosen the fastener.

The engaging surfaces of conventional wrenches are often constructed to maximize the engaging surface area with the edge surfaces of the fastener to distribute a force applied to the fastener across the surface. As such, a properly sized or adjusted wrench may be required to slide onto the fastener at a precise angle to facilitate engagement. If such as conventional wrench approaches the fastener at an angle to the edge surfaces, the wrench may not be able engage with the fastener, and may require the user to maneuver the wrench around the fastener until the proper approach angle is achieve to allow for proper engagement. This difficulty with engaging the fastener can slow the tightening process and create inefficiencies. Further, in some instances, removal of the wrench from the fastener after being engaged with the fastener can also require manipulation of the wrench to achieve the proper removal orientation to disengage the wrench from the fastener, again leading to inefficiencies.

Accordingly, it would be beneficial to develop a wrench that improve the ease of engaging with or disengaging from a fastener to increase the efficiency of tightening or untightening operations.

### BRIEF SUMMARY OF SOME EXAMPLES

According to some example embodiments, an example wrench is provided. The example wrench includes a first jaw having a first jaw engaging surface configured to engage a first side of a fastener and a second jaw having a second jaw engaging surface configured to engage a second side of a fastener. A first plane defined by the first jaw engaging surface may intersect with a second plane defined by the second jaw engaging surface at an engagement angle. The engagement angle may be an acute angle.

According to some example embodiments, another example wrench is provided. The example wrench may comprise a first jaw having a first jaw engaging surface configured to engage a first side of a fastener. In this regard, the first jaw engaging surface may have a front edge, a first side edge, and a second side edge. The example wrench may further comprise a second jaw having a second jaw engaging surface configured to engage a second side of a fastener, and a first side chamfered surface disposed adjacent to the first side edge. A first plane defined by the first jaw engaging surface may intersect with a second plane defined by the first side chamfered surface at a first side chamfered surface angle. The first side chamfered surface angle may be an acute angle.

According to some example embodiments, another example wrench is provided. The example wrench may comprise a first jaw having a first jaw engaging surface configured to engage a first side of a fastener. The first jaw engaging surface may have a front edge, a first side edge, and a second side edge. The example wrench may further comprise a second jaw having a second jaw engaging surface configured to engage a second side of a fastener, and a first chamfered surface disposed adjacent to the first side edge. A first plane defined by the first jaw engaging surface may intersect with a second plane defined by the second jaw engaging surface at an engagement angle. The engagement angle may be a first acute angle. The first plane defined by the first jaw engaging surface may also intersect with a third plane defined by the first chamfered surface at a first chamfered surface angle. The first chamfered surface angle may be a second acute angle.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a side view of an example wrench according to some example embodiments;

FIG. 2 illustrates a zoomed side view of the jaws of the wrench shown in FIG. 1 according to some example embodiments;

FIG. 3 illustrates a side view of a head of the wrench of FIG. 1 in engagement with a fastener according to some example embodiments;

FIG. 4 illustrates a zoomed side view of an engagement between the fastener and lower jaw as shown in FIG. 3 according to some example embodiments;

FIG. 5 illustrates a side view of another example wrench according to some example embodiments;

FIG. 6 illustrates a perspective view of the wrench of FIG. 5 and showing details of the engaging surface of the upper jaw according to some example embodiments;

FIG. 7 illustrates a zoomed side view of an upper jaw of the wrench of FIG. 5 according to some example embodiments;

FIG. 8 illustrates a zoomed front view of an upper jaw of the wrench of FIG. 5 according to some example embodiments;

FIG. 9 illustrates a perspective view of the wrench of FIG. 5 and showing details of the engaging surface of the lower jaw according to some example embodiments;

FIG. 10 illustrates a zoomed side view of the lower jaw of the wrench of FIG. 5 according to some example embodiments; and

FIG. 11 illustrates a zoomed front view of the lower jaw of the wrench of FIG. 5 according to some example embodiments.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability, or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

In view of the above, some example embodiments are directed to a wrench that includes specifically configured engaging surfaces to facilitate easy engagement and removal of the wrench to or from a fastener (e.g., a hexagonal-shaped fastener). In this regard, according to some example embodiments, a wrench may be provided that includes jaws, for example a first jaw and a second jaw, configured to engage opposite sides of a fastener. Each jaw may include a respective engaging surface that is positioned to engage a respective side of the fastener. While the opposing sides of the fastener may extend in parallel planes, according to some example embodiments, the engaging surfaces of the jaws of the wrench need not be disposed on parallel planes. Rather, the engaging surfaces may be non-parallel and planes defined by the each of the engaging surfaces of the wrench jaws may intersect to form an engagement angle that opens towards a front end of the wrench. According to some example embodiments, the engagement angle may be an acute angle with a vertex located behind or rearward of the jaw opening (e.g., on the handle-side of the wrench head comprising the jaws).

Due to the angled relationship between the engaging surfaces, an engaging surface of a first jaw may be fully seated on a side of the fastener, while an engaging surface of a second jaw may only be partially seated on another side of the fastener, but rather in contact across a translational line segment thereby forming a pie-shaped gap between the side of the fastener and the engaging surface of the jaw. Due to the partially seated engagement with one side of the fastener, removal of the wrench from the fastener can occur more readily and with greater ease. The pie-shaped gap, which may have the same angle as the engaging angle, may allow the jaws to be slightly rotated and slid out of engagement with the fastener, without requiring disengagement by movement of the wrench in parallel with the sides of the fastener. Additionally, the fastener may be more readily engaged with the jaws when applying the wrench to the fastener for similar reasons.

Additionally, according to some example embodiments, a wrench is provided that includes angled or beveled surfaces around the engaging surfaces of the jaws. In this regard, an engagement surface of a j aw of a wrench may include a front edge and two side edges and beveled or chamfered surfaces may be disposed adjacent to these edges of the engaging surface. As such, a front chamfered surface may be disposed adjacent to the front edge and side chamfered surfaces may be disposed adjacent to the side edges. Respective planes defined by the chamfered surfaces may intersect with a plane defined by the engaging surface at respective chamfered surface angles. These chamfered surface angles may be acute angles.

The inclusion of the chamfered surfaces around the engaging surfaces of the jaws of the wrench may also facilitate easy application of the wrench onto a fastener and easy removal of the wrench from a fastener. Particularly with respect to application of the wrench onto a fastener, the chamfered surfaces can operate to guide the wrench into engagement between the sides of the fastener and the engaging surfaces of the wrench. As such, wrenches, such as adjustable wrenches or combination wrenches, that include both engaging surfaces disposed at an engagement angle and chamfered surfaces around the engaging surfaces can more readily engage and disengage from a fastener and thus improve the efficiency of a user of the wrench when having to perform tightening or loosening operations on many fasteners, such as, at a construction site or on a manufacturing assembly line.

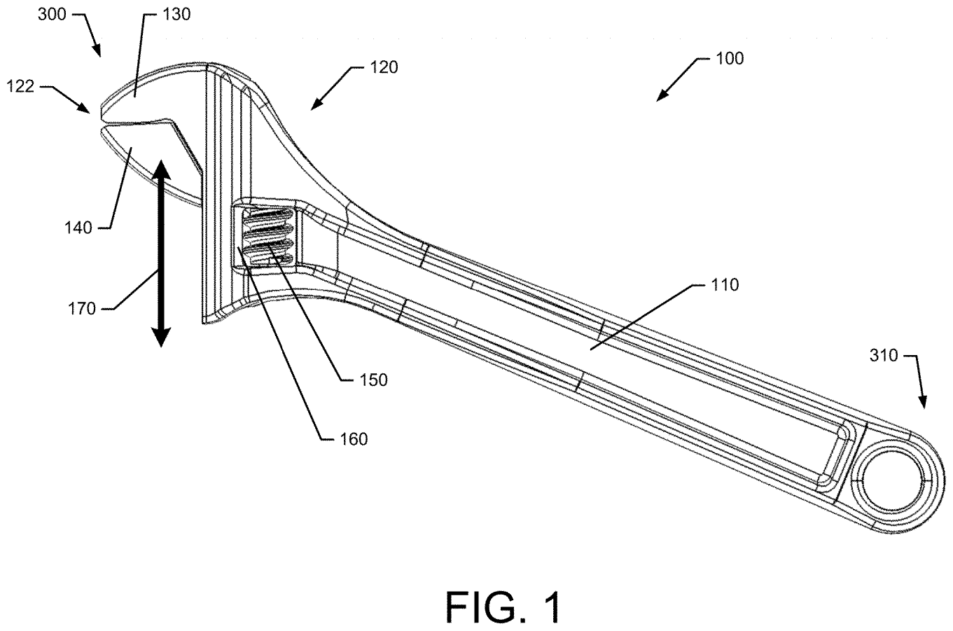

FIG. 1 illustrates a side view of an example wrench 100 with jaws that include engagement surfaces have an engagement angle. The wrench 100 may comprise a handle 110 and a head 120. The handle 110 may be affixed to the head 120 and the head 120 may be disposed forward of the handle 110. In this regard, the handle 120 may extend from the head 120 in a rearward direction towards a rear end 310 of the wrench 100. The head 110 may extend from the handle 110 in a forward direction to a front end 300 of the wrench 100.

The head 120 of the wrench 100 may include a first (or upper) jaw 130 and a second (or lower) jaw 140. The jaws 130 and 140 may form a fastener engagement opening 122 disposed between the first jaw 130 and the second jaw 140 that is configured to receive a fastener. Although some example embodiments may be employed within the context of a fixed-jaw wrench (e.g., a combination wrench), according to some example embodiments, the wrench 100 may be an adjustable wrench and therefore the first jaw 130 may be a fixed jaw and the second jaw 140 may be movable relative to the first jaw 130. In this regard, according to some example embodiments, the second jaw 140 may be movable in the direction of the arrows 170 to either increase the size of the fastener engagement opening 122 or decrease the size of the fastener engagement opening 122. The wrench 100, as shown in FIG. 1, illustrates the jaws 130 and 140 in a substantially closed position. To cause movement of the second jaw 140, the wrench 100 may include a turnable knurl 150 (or wormscrew) that interfaces with a slotted pin 160 that is coupled to or integrated with the second jaw 140. When a user turns the knurl 150, the pin 160, and thus the second jaw 140 is caused to move in the one of the directions indicated by the arrows 170, depending on the direction of rotation of the knurl 150. According to some example embodiments, the pin 160 may also be coupled to a spring (not shown) to place a load force on the pin 160 to maintain engagement between the knurl 150 and the pin 160 and avoid unintended movement of the second jaw 140 (e.g., due to jarring).

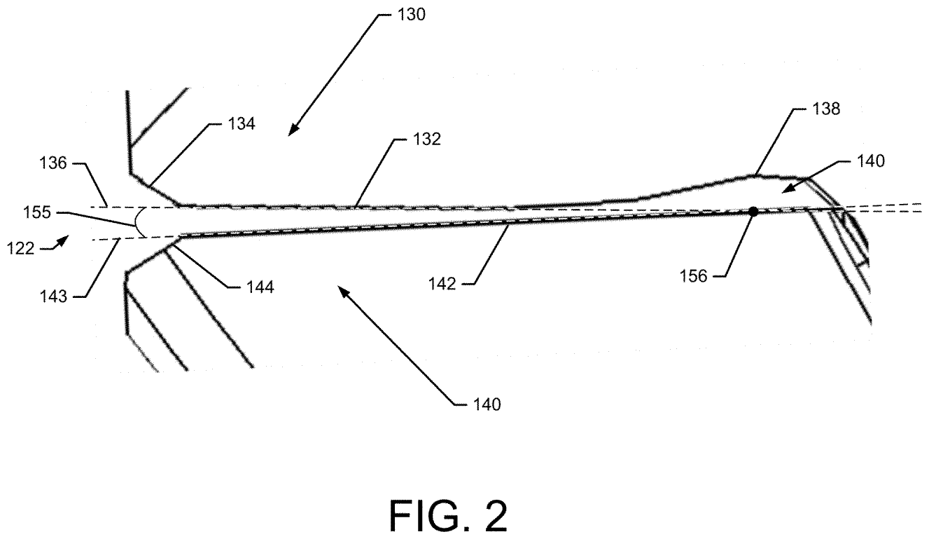

FIG. 2 illustrates a zoomed side view of the jaws 130 and 140 of the wrench 100 as shown in FIG. 1 with additional detail. The first jaw 130 is shown as comprising a first engaging surface 132 that is configured to engage with a side of a fastener and may be formed as a flat rectangular surface that faces into the fastener engagement opening 122 and generally extends from a front end of the first jaw 130 to a rear end of the first jaw 130. As such, the first engaging surface 132 may define a plane 136 that extends from the edges of the first engaging surface 132.

The first jaw 130 may also include, for example, a front chamfered surface 134 (further described below) forward of and adjacent to the first engaging surface 132. Additionally, according to some example embodiments, the first jaw 130 may include a curved surface 138 that is disposed rearward of the first engaging surface 132. This curved surface 138, which may be adjacent to and rearward of the first engagement surface 132, may form an off corner loading recess 140 within the fastener engagement opening 122. The off corner loading recess 140 may form a cavity near a rear portion of the fastener engagement opening 122 (e.g., the seat), and the off corner load recess 140 may operate to facilitate removal of the wrench 100 from a fastener.

The second jaw 140, which may be movable, may include a second engaging surface 142. The second engaging surface 142 may be configured to engage with another side of a fastener and the second engaging surface 142 may be formed as a flat rectangular surface that faces into the fastener engagement opening 122 and generally extends from a front end of the second jaw 140 to a rear end of the second jaw 140. As such, the second engaging surface 142 may define a plane 143 that extends from the edges of the second engaging surface 142. Additionally, the second jaw 140 may also include, for example, a front chamfered surface 144 (further described below) forward of and adjacent to the second engaging surface 142.

As shown in FIG. 2, the plane 136 and the plane 143 (associated with respective engaging surfaces) are not parallel and, thus the planes 136 and 143 intersect at a line 156 (represented as a point). As such, the intersection of the planes 136 and 143 forms an engagement angle 155, which also defines the angle between first engaging surface 132 and the second engaging surface 142. According to some example embodiments, because the movement of the second jaw 140 is linear, the engagement angle may be constant, even with the second jaw 140 in a different position (although the location of the intersection line 156 may move). Accordingly, the engagement angle 155 may be an acute angle (i.e., less than ninety degrees). Further, according to some example embodiments, the engagement angle 155 may be between about two degrees to about five degrees. According to some example embodiments, the engagement angle 155 may be about three degrees.

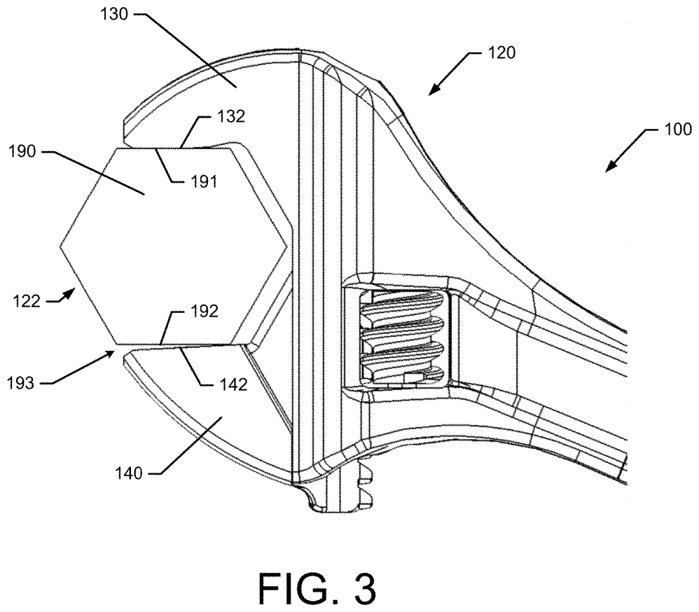

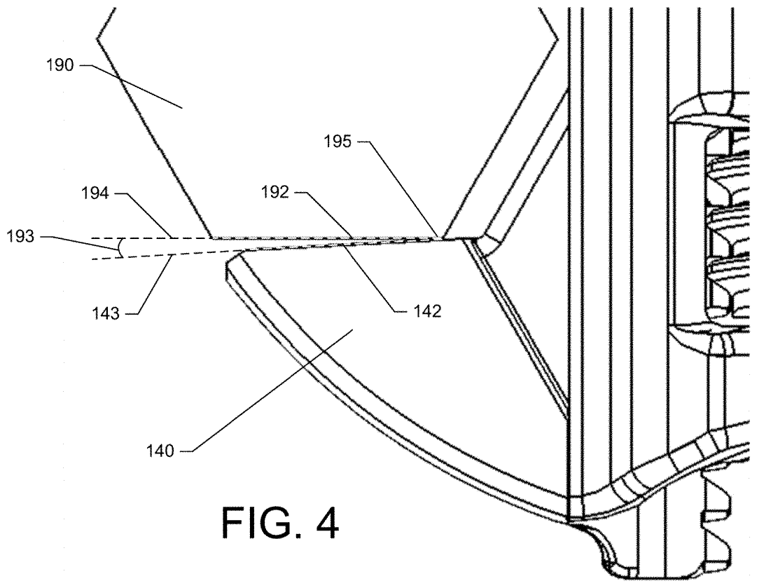

Referring now to FIGS. 3 and 4, a side view of the head 120 of wrench 100 is shown in engagement with a fastener 190. The fastener 190 is shown as an example hexagonal-shaped fastener. The second jaw 140 of the wrench 100 has been moved to increase the size of the fastener engagement opening 122 to permit the fastener 190 to be received into the fastener engagement opening 122. As a result of the engagement between the jaws 130, 140 and the fastener 190, the first engaging surface 132 of the first jaw 130 is engaged with a first side 191 of the fastener 190, and the second engaging surface 142 of the second jaw 140 is engaged with a second side 192 (e.g., disposed opposite to the first side 191) of the fastener 190.

The first engaging surface 132 of the first jaw 130 is fully seated onto the first side 191 of the fastener 190. This fully seated engagement may involve, according to some example embodiments, substantially the entire surface area of the first engaging surface 132 being in contact with the first side 191. In situations where the lateral width of the first engaging surface 132 is larger than the lateral width of the first side 191 of the fastener, a fully seated first engaging surface 132 may be in contact with the first side 191 of the fastener 190 from at least a front end of the first engaging surface 132 to a rear end of the first engaging surface 132, but not necessarily across the entire lateral width of the first engaging surface 132.

As shown in FIG. 3, the second engaging surface 142 of the second jaw 140 is also engaged with the second side 192 of the fastener 190, but only partially engaged. In this regard, it can be seen that, because the first engaging surface 132 is not parallel with the second engaging surface 142, both engaging surfaces cannot be fully engaged with the parallel sides of the fastener 190. As such, an angular or pie-shaped gap is formed between the second side 192 and the second engaging surface 142, such that the second engaging surface 142 is only partially seated to the second side 192 of the fastener 190. In this regard, according to some example embodiments, a partial seating or partial engagement involves contact between the second engaging surface 142 that does not extend from a front end of the second engaging surface 142 to a rear end of the second engaging surface 142. As such, a linear segment contact (i.e., contact along a line) between the second side 192 of the fastener 190 and the second engaging surface 142 may be an example of a partially seated engagement.

FIG. 4 shows a zoomed side view of the head 120 of the wrench 100, focusing on the engagement between the second side 192 and the second engaging surface 142 of the second jaw 140. As can be seen, because the first side 191 of the fastener 190 is fully seated on the first engaging surface 132 (and the first side 191 of the fastener 190 is parallel to the second side 192 of the fastener 190), the second side 192 of the fastener 190 engages with the second engaging surface 142 at a point 195, which actually forms a line segment engagement across the engagement between the second engaging surface 142 and the second side 192 of the fastener 190. As such, the second engaging surface 142 may be partially seated on the second side 192 of the fastener 190. Due to this partial seating, an angular or pie-shaped gap may be formed between the second side 192 of the fastener 190 and the second engaging surface 142. In this regard, the surface of the second side 192 of the fastener 190 may define a plane 194 and the second engaging surface 142 may define the plane 143. Due to the partial seating, the plane 194 may intersect with the plane 143 at a fastener engagement angle 193, which may be an acute angle, having a vertex at the line segment of engagement between the second side 192 of the fastener 190 and the second engaging surface 142. It is noted that, due to the parallel nature of the opposing sides of the fastener 190 and the fully seated positioning of the first engaging surface 132, the fastener engagement angle 193 may have the same angular measurement (e.g., in degrees) as the engagement angle 155 between the engaging surfaces. Further, it is this fastener engagement angle 193 that facilitates easier removal of the wrench 100 from the fastener 190 by permitting some rotational manipulation of the wrench 100 during a removal operation into the pie-shaped gap defined by the fastener engagement angle 193.

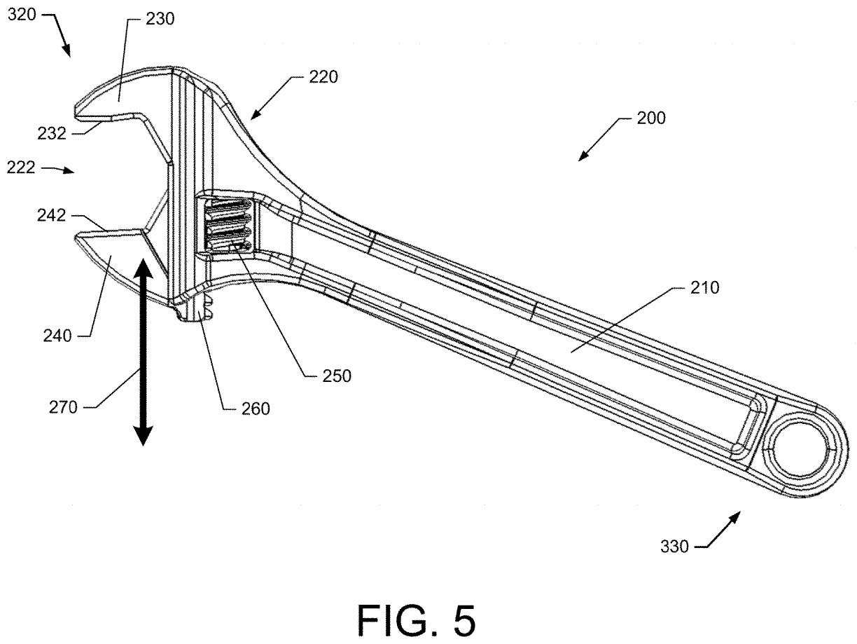

Now referring to FIG. 5, another wrench 200, according to some example embodiments, is shown. In this regard, FIG. 5 illustrates a side view of an example wrench 200 with jaws that include a first engagement surface 232 and a second engaging surface 242 that form a fastener engagement opening 222 therebetween and an engagement angle as described above. Similar to the wrench 100, the wrench 200 may comprise a handle 210 and a head 220. The handle 210 may be affixed to the head 220 and the head 220 may be disposed forward of the handle 210. In this regard, the handle 220 may extend from the head 220 in a rearward direction towards a rear end 330 of the wrench 200. The head 210 may extend from the handle 210 in a forward direction to a front end 320 of the wrench 200.

The head 220 of the wrench 200 may include a first (or upper) jaw 230 and a second (or lower) jaw 240. The jaws 230 and 240 may form the fastener engagement opening 222 disposed between the first jaw 230 and the second jaw 240, and between the first engagement surface 232 and the second engaging surface 242, that is configured to receive a fastener. Although some example embodiments may be employed within the context of a fixed-jaw wrench (e.g., a combination wrench), according to some example embodiments, the wrench 200 may be an adjustable wrench and therefore the first jaw 230 may be a fixed jaw and the second jaw 240 may be movable relative to the first jaw 230. In this regard, according to some example embodiments, the second jaw 240 may be movable in the direction of the arrows 270 to either increase the size of the fastener engagement opening 222 or decrease the size of the fastener engagement opening 222. The wrench 200, as shown in FIG. 5, illustrates the jaws 230 and 240 in an open position. To cause movement of the second jaw 240, the wrench 200 may include a turnable knurl 250 (or wormscrew) that interfaces with a slotted pin 260 that is coupled to or integrated with the second jaw 240. When a user turns the knurl 250, the pin 260, and thus the second jaw 240 is caused to move in one of the directions indicated by the arrows 270, depending on the direction of rotation of the knurl 250. According to some example embodiments, the pin 260 may also be coupled to a spring (not shown) to place a load force on the pin 260 to maintain engagement between the knurl 250 and the pin 260 and avoid unintended movement of the second jaw 240 (e.g., due to jarring).

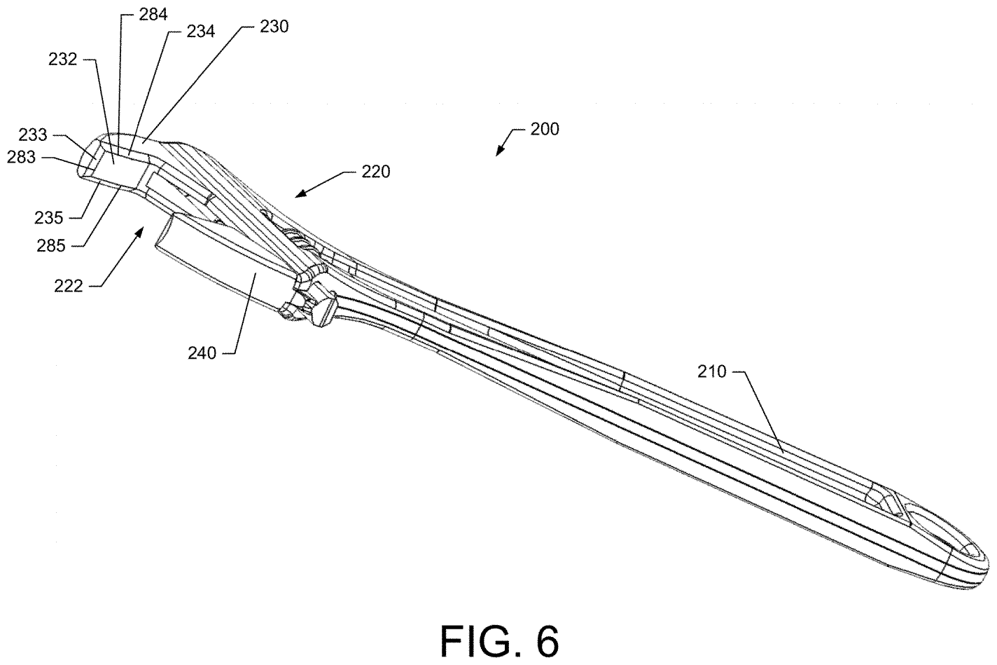

As better shown in FIGS. 6 to 11, the wrench 200 may include chamfered surfaces around the edges of the engaging surfaces of either or both of the jaws 230 and 240. To illustrate example embodiments that include such chamfered surfaces as provided herein, FIG. 6 illustrates the wrench 200 in a perspective view to more clearly show the surfaces of the first jaw 230.

In this regard, the first jaw 230 comprises first engagement surface 232. The first engagement surface 232 may be configured to engage with a side of a fastener and the first engagement surface 232 may be formed as a flat rectangular surface that faces into the fastener engagement opening 222 and, according to some example embodiments, generally extends from a position at or near a front end of the first jaw 230 to a position at or near a rear end of the first jaw 230. The first engagement surface 232 may have a front edge 283 disposed at a forward end of the first engagement surface 232. The first engagement surface 232 may also have a first side edge 284 and a second side edge 285 disposed on opposite sides of the first engagement surface 232.

According to some example embodiments, a front chamfered surface 233 may be disposed adjacent to the front edge 283 of the first engagement surface 232. In this regard, the front edge 283 of the first engagement surface 232 may also be a rear edge of the front chamfered surface 233. A first side chamfered surface 234 may be disposed adjacent to the first side edge 284 of the first engagement surface 232. In this regard, the first side edge 284 of the first engagement surface 232 may also be a shared side edge with the first side chamfered surface 234. A second side chamfered surface 235 may be disposed adjacent to the second side edge 285 of the first engagement surface 232. In this regard, the second side edge 285 of the first engagement surface 232 may also be a shared side edge with the second side chamfered surface 235.

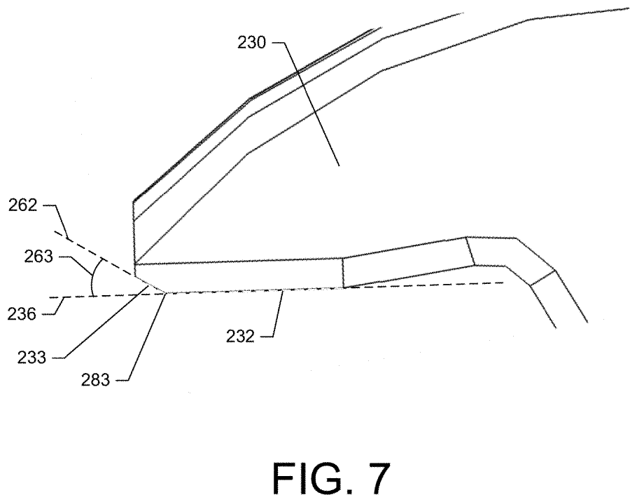

Providing additional detail with regard to the front chamfered surface 233, FIG. 7 provides a zoomed side view of a portion of the first jaw 230. In this regard, the first engagement surface 232 is shown in relation to a plane 236 defined by the first engagement surface 232. The front chamfered surface 233 is disposed adjacent to the front edge 283 of the first engagement surface 232 and extending from the first engagement surface 232 in a forward direction. The front chamfered surface 233 defines a plane 262 that intersects with the plane 236 of the first engagement surface 232. Due to the chamfered or beveled disposition of the front chamfered surface 233, the plane 262 intersects with the plane 236 at the front edge 283 to define a forward-facing front chamfered surface angle 263, which may be an acute angle. According to some example embodiments, the front chamfered surface angle 263 may be between about twenty degrees and about thirty degrees. As described above, this front chamfered surface angle 263 can assist with guiding a fastener into the fastener engagement opening 222 when the wrench 200 is initially being engaged with the fastener from the front of the wrench 200.

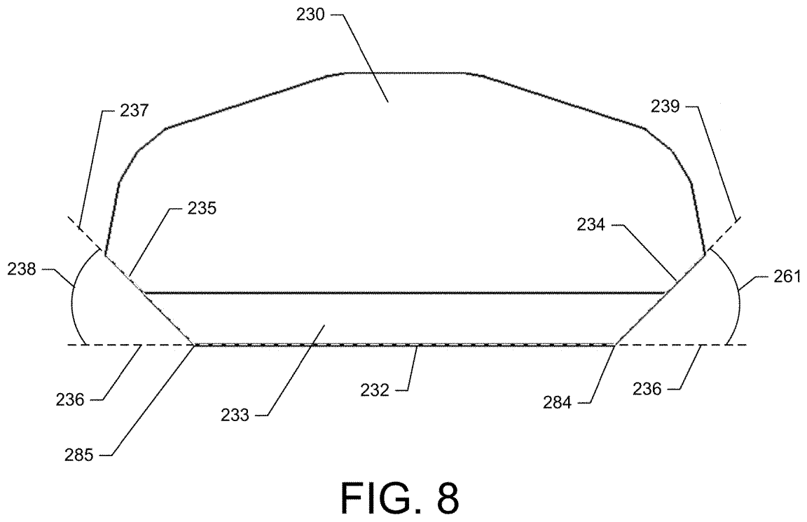

Additionally, to provide additional detail with regard to the side chamfered surfaces 234 and 235, FIG. 8 provides a zoomed front view of a portion of the first jaw 230. In this regard, the first engagement surface 232 is shown in relation to a plane 236 which is defined by the first engagement surface 232. The side chamfered surface 234 is disposed adjacent to the side edge 284 of the first engagement surface 232 and extends from the first engagement surface 232 in a sideways direction. The side chamfered surface 234 defines a plane 239 that intersects with the plane 236 of the first engagement surface 232. Due to the chamfered or beveled disposition of the side chamfered surface 234, the plane 239 intersects with the plane 236 at the side edge 284 to define a side-facing side chamfered surface angle 261, which may be an acute angle. According to some example embodiments, the side chamfered surface angle 261 may be between about twenty degrees and about thirty degrees.

Similarly, on the side opposite the side edge 284, the other side chamfered surface 235 may be disposed adjacent to the side edge 285 of the first engagement surface 232 and extends from the first engagement surface 232 in a sideways direction. The side chamfered surface 235 defines a plane 237 that intersects with the plane 236 of the first engagement surface 232. Due to the chamfered or beveled disposition of the side chamfered surface 235, the plane 237 intersects with the plane 236 at the side edge 285 to define a side-facing side chamfered surface angle 238, which may be an acute angle. According to some example embodiments, the side chamfered surface angle 238 may be between about twenty degrees and about thirty degrees.

Additionally, these side chamfered surfaces 234 and 235, defining their respective side chamfered surface angles 238 and 261, can also assist with guiding a fastener into the fastener engagement opening 222 when the wrench 200 is initially being engaged with the fastener from a side of the wrench 200. In this regard, if a slight misplacement of the wrench 200 occurs while a user is attempting to engage a fastener from the side of the wrench 200, one of the side chamfered surfaces 234 or 235 may interact with the fastener and the fastener may ride along the chamfered or beveled surface into the fastener engagement opening 222.

[symbol]

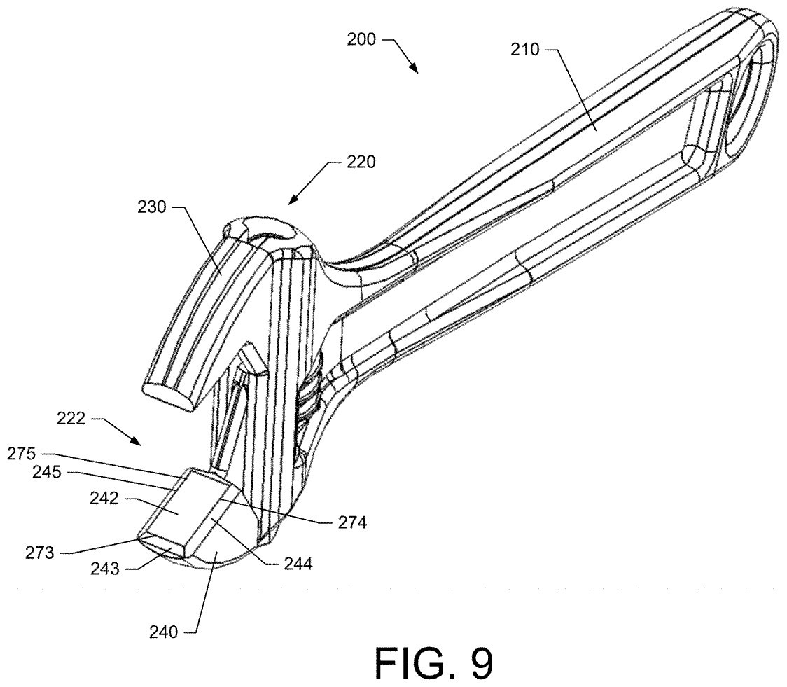

Further, with respect to FIGS. 9 to 11, the wrench 200 may also include chamfered surfaces around the edges of the engaging surface of the second jaw 240. To illustrate example embodiments that include such chamfered surfaces as provided herein, FIG. 9 illustrates the wrench 200 in a perspective view to more clearly show the surfaces of the second jaw 240.

In this regard, the second jaw 240 comprises second engaging surface 242. The second engaging surface 242 may be configured to engage with a side of a fastener and the second engaging surface 242 may be formed as a flat rectangular surface that faces into the fastener engagement opening 222 and, according to some example embodiments, generally extends from at or near a front end of the second jaw 240 to at or near a rear end of the second jaw 240. The second engaging surface 242 may have a front edge 273 disposed at a forward end of the second engaging surface 242. The second engaging surface 242 may also have a first side edge 274 and a second side edge 275 disposed on opposite sides of the second engaging surface 242.

According to some example embodiments, a front chamfered surface 243 may be disposed adjacent to the front edge 273 of the second engaging surface 242. In this regard, the front edge 273 of the second engaging surface 242 may also be a rear edge of the front chamfered surface 243. A first side chamfered surface 244 may be disposed adjacent to the first side edge 274 of the second engaging surface 242. In this regard, the first side edge 274 of the second engaging surface 242 may also be a shared side edge with the first side chamfered surface 244. A second side chamfered surface 245 may be disposed adjacent to the second side edge 275 of the second engaging surface 242. In this regard, the second side edge 275 of the second engaging surface 242 may also be a shared side edge with the second side chamfered surface 245.

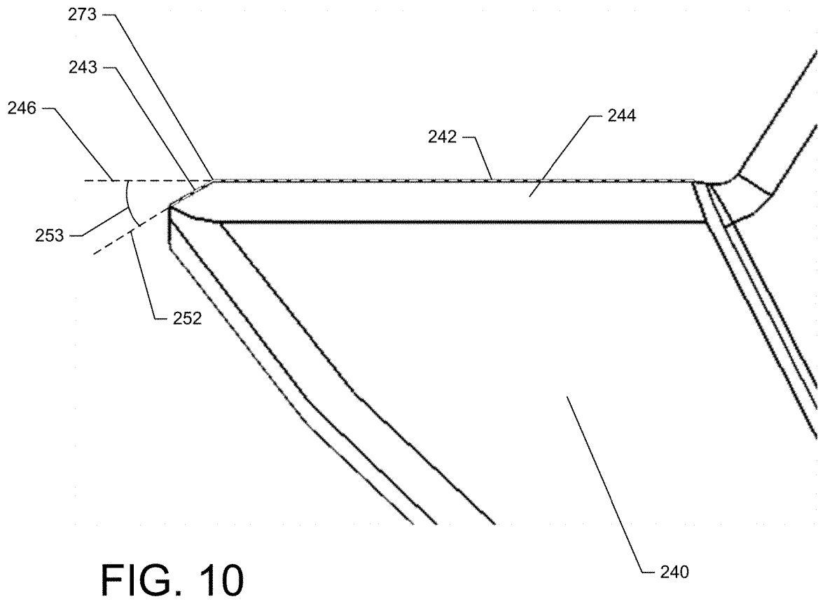

Providing additional detail with regard to the front chamfered surface 243, FIG. 10 provides a zoomed side view of a portion of the second jaw 240. In this regard, the second engaging surface 242 is shown in relation to a plane 246 defined by the second engaging surface 242. The front chamfered surface 243 is disposed adjacent to the front edge 273 of the second engaging surface 242 and extending from the second engaging surface 242 in a forward direction. The front chamfered surface 243 defines a plane 252 that intersects with the plane 246 of the second engaging surface 242. Due to the chamfered or beveled disposition of the front chamfered surface 243, the plane 252 intersects with the plane 246 at the front edge 273 to define a forward-facing front chamfered surface angle 253, which may be an acute angle. According to some example embodiments, the front chamfered surface angle 253 may be between about twenty degrees and about thirty degrees. As described above, this front chamfered surface angle 253 can assist with guiding a fastener into the fastener engagement opening 222 when the wrench 200 is initially being engaged with the fastener from the front of the wrench 200.

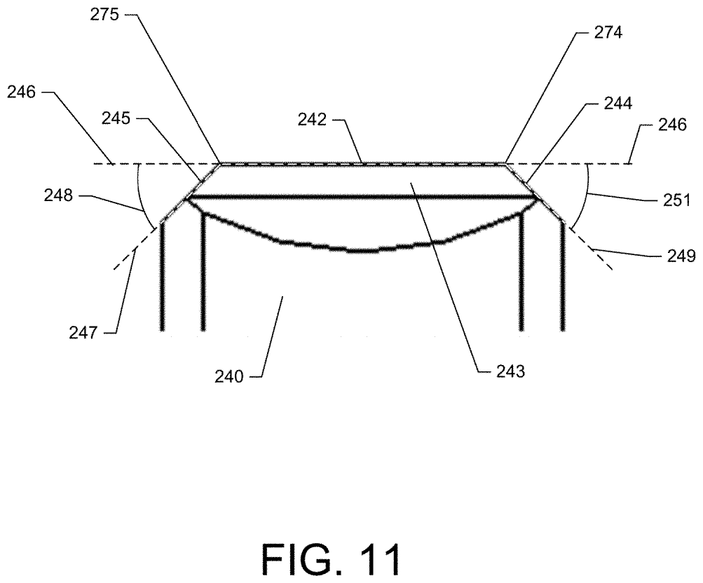

Additionally, to provide additional detail with regard to the side chamfered surfaces 244 and 245, FIG. 11 provides a zoomed front view of a portion of the second jaw 240. In this regard, the second engaging surface 242 is shown in relation to a plane 246 which is defined by the second engaging surface 242. The side chamfered surface 244 is disposed adjacent to the side edge 274 of the second engaging surface 242 and extends from the second engaging surface 242 in a sideways direction. The side chamfered surface 244 defines a plane 249 that intersects with the plane 246 of the second engaging surface 242. Due to the chamfered or beveled disposition of the side chamfered surface 244, the plane 249 intersects with the plane 246 at the side edge 274 to define a side-facing side chamfered surface angle 251, which may be an acute angle. According to some example embodiments, the side chamfered surface angle 251 may be between about twenty degrees and about thirty degrees.

Similarly, on the side opposite the side edge 274, the other side chamfered surface 245 may be disposed adjacent to the side edge 275 of the second engaging surface 242 and extends from the second engaging surface 242 in a sideways direction. The side chamfered surface 245 defines a plane 247 that intersects with the plane 246 of the second engaging surface 242. Due to the chamfered or beveled disposition of the side chamfered surface 245, the plane 247 intersects with the plane 246 at the side edge 275 to define a side-facing side chamfered surface angle 248, which may be an acute angle. According to some example embodiments, the side chamfered surface angle 248 may be between about twenty degrees and about thirty degrees.

Additionally, these side chamfered surfaces 244 and 245, defining their respective side chamfered surface angles 248 and 251, can also assist with guiding a fastener into the fastener engagement opening 222 when the wrench 200 is initially being engaged with the fastener from a side of the wrench 200. In this regard, if a slight misplacement of the wrench 200 occurs while a user is attempting to engage a fastener from the side of the wrench 200, one of the side chamfered surfaces 244 or 245 may interact with the fastener and the fastener may ride along the chamfered or beveled surface into the fastener engagement opening 222.

In light of the foregoing, an example wrench is provided according to some example embodiments. The example wrench may comprise a first jaw having a first jaw engaging surface configured to engage a first side of a fastener and a second jaw having a second jaw engaging surface configured to engage a second side of a fastener. A first plane defined by the first jaw engaging surface may intersect with a second plane defined by the second jaw engaging surface at an engagement angle. The engagement angle may be an acute angle. Additionally, according to some example embodiments, the engagement angle may be between two degrees and five degrees. Additionally or alternatively, the first jaw engaging surface comprises a front edge, a first side edge, and a second side edge, and the first jaw may further comprise a first chamfered surface disposed adjacent to the front edge, the first side edge, or the second side edge. In this regard, the first plane defined by the first jaw engaging surface may intersect with a third plane defined by the first chamfered surface at a first chamfered surface angle. The first chamfered surface angle may be an acute angle. Additionally or alternatively, the engagement angle may be about three degrees. Additionally or alternatively, the second jaw may be movable relative to the first jaw. Additionally or alternatively, when the first side of the fastener is fully engaged with the first jaw engaging surface, the second side of the fastener may be partially engaged with the second jaw engaging surface. Additionally or alternatively, the first jaw comprises an off corner loading recess disposed adjacent to the first jaw engaging surface. Additionally or alternatively, the wrench may comprise a fixed-jaw or combination wrench.

According to some example embodiments, another example wrench is provided that comprises a first jaw having a first jaw engaging surface configured to engage a first side of a fastener. The first jaw engaging surface may have a front edge, a first side edge, and a second side edge. The example wrench may also comprise a second jaw having a second jaw engaging surface configured to engage a second side of a fastener, and a first side chamfered surface disposed adjacent to the first side edge. In this regard, a first plane defined by the first jaw engaging surface may intersect with a second plane defined by the first side chamfered surface at a first side chamfered surface angle. The first side chamfered surface angle may be an acute angle. Additionally, according to some example embodiments, the first side chamfered surface angle may be between twenty degrees and thirty degrees. Additionally or alternatively, the example wrench may further comprise a front chamfered surface disposed adjacent to the front edge. The first plane defined by the first jaw engaging surface may intersect with a third plane defined by the front chamfered surface at a front chamfered surface angle. The front chamfered surface angle being an acute angle. Additionally or alternatively, the front chamfered surface angle may be between twenty degrees and thirty degrees. Additionally or alternatively, the first side chamfered surface angle and the front chamfered surface angle may have substantially the same angle measurement. Additionally or alternatively, the first side chamfered surface may be configured to guide the fastener into engagement with the first side engagement surface. Additionally or alternatively, the second jaw engaging surface may comprise a second jaw front edge and a second jaw first side edge, and the example wrench may further comprise a second jaw first side chamfered surface disposed adjacent to the second jaw first side edge. Further, a third plane defined by the second jaw engaging surface may intersect with a fourth plane defined by the second jaw first side chamfered surface at a second jaw first side chamfered surface angle. The second jaw first side chamfered surface angle being an acute angle. Additionally or alternatively, the first side chamfered surface angle and the second jaw first side chamfered surface angle have substantially the same angle measurement. Additionally or alternatively, the second jaw may movable relative to the first jaw or the first and the second jaws may be fixed.

According to some example embodiments, another example wrench is provided. In this regard, the example wrench may comprise a first jaw having a first jaw engaging surface configured to engage a first side of a fastener. The first jaw engaging surface may have a front edge, a first side edge, and a second side edge. The example wrench may further comprise a second jaw having a second jaw engaging surface configured to engage a second side of a fastener, and a first chamfered surface disposed adjacent to the first side edge. A first plane defined by the first jaw engaging surface may intersect with a second plane defined by the second jaw engaging surface at an engagement angle. The engagement angle may be a first acute angle. The first plane defined by the first jaw engaging surface may intersect with a third plane defined by the first chamfered surface at a first chamfered surface angle. The first chamfered surface angle may be a second acute angle. Additionally, the engagement angle may be between two degrees and five degrees, and the first chamfered surface angle may be between twenty degrees and thirty degrees. Additionally or alternatively, the second jaw is movable relative to the first jaw.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A wrench comprising:
a first jaw having a first jaw engaging surface configured to engage a first side of a fastener; and
a second jaw having a second jaw engaging surface configured to engage a second side of a fastener;
wherein a first plane defined by the first jaw engaging surface intersects with a second plane defined by the second jaw engaging surface at an engagement angle, the engagement angle being an acute angle.

2. The wrench of claim 1, wherein the engagement angle is between two degrees and five degrees.

3. The wrench of claim 1, wherein the first jaw engaging surface comprises a front edge, a first side edge, and a second side edge;
wherein the first jaw further comprises a first chamfered surface disposed adjacent to the front edge, the first side edge, or the second side edge;
wherein the first plane defined by the first jaw engaging surface intersects with a third plane defined by the first chamfered surface at a first chamfered surface angle, the first chamfered surface angle being an acute angle.

4. The wrench of claim 1, where the engagement angle is about three degrees.

5. The wrench of claim 1, wherein the second jaw is movable relative to the first jaw.

6. The wrench of claim 1, wherein when the first side of the fastener is fully engaged with the first jaw engaging surface, the second side of the fastener is partially engaged with the second jaw engaging surface.

7. The wrench of claim 1, wherein the first jaw comprises an off corner loading recess disposed adjacent to the first jaw engaging surface.

8. The wrench of claim 1, wherein the wrench comprises a combination wrench.

9. A wrench comprising:
a first jaw having a first jaw engaging surface configured to engage a first side of a fastener, the first jaw engaging surface having a front edge, a first side edge, and a second side edge;
a second jaw having a second jaw engaging surface configured to engage a second side of a fastener; and
a first side chamfered surface disposed adjacent to the first side edge;
wherein a first plane defined by the first jaw engaging surface intersects with a second plane defined by the first side chamfered surface at a first side chamfered surface angle, the first side chamfered surface angle being an acute angle.

10. The wrench of claim 9 wherein the first side chamfered surface angle is between twenty degrees and thirty degrees.

11. The wrench of claim 9 further comprising a front chamfered surface disposed adjacent to the front edge;
wherein the first plane defined by the first jaw engaging surface intersects with a third plane defined by the front chamfered surface at a front chamfered surface angle, the front chamfered surface angle being an acute angle.

12. The wrench of claim 11 wherein the front chamfered surface angle is between twenty degrees and thirty degrees.

13. The wrench of claim 11, wherein the first side chamfered surface angle and the front chamfered surface angle have substantially the same angle measurement.

14. The wrench of claim 9, wherein the first side chamfered surface is configured to guide the fastener into engagement with the first side engagement surface.

15. The wrench of claim 9, wherein the second jaw engaging surface comprises a second jaw front edge and a second jaw first side edge;
wherein the wrench further comprises a second jaw first side chamfered surface disposed adjacent to the second jaw first side edge;
wherein a third plane defined by the second jaw engaging surface intersects with a fourth plane defined by the second jaw first side chamfered surface at a second jaw first side chamfered surface angle, the second jaw first side chamfered surface angle being an acute angle.

16. The wrench of claim 15, wherein the first side chamfered surface angle and the second jaw first side chamfered surface angle have substantially the same angle measurement.

17. The wrench of claim 9, wherein the second jaw is movable relative to the first jaw.

18. A wrench comprising:
a first jaw having a first jaw engaging surface configured to engage a first side of a fastener, the first jaw engaging surface having a front edge, a first side edge, and a second side edge;
a second jaw having a second jaw engaging surface configured to engage a second side of a fastener; and
a first chamfered surface disposed adjacent to the first side edge;
wherein a first plane defined by the first jaw engaging surface intersects with a second plane defined by the second jaw engaging surface at an engagement angle, the engagement angle being a first acute angle;
wherein the first plane defined by the first jaw engaging surface intersects with a third plane defined by the first chamfered surface at a first chamfered surface angle, the first chamfered surface angle being a second acute angle.

19. The wrench of claim 18, wherein the engagement angle is between two degrees and five degrees, and
wherein the irst chamfered surface angle is between twenty degrees and thirty degrees.

20. The wrench of claim 18, wherein the second jaw is movable relative to the first jaw.
